(19) United States
(12) Patent Application Publication
(10) Pub. No.: US 2011/0294059 A1
(43) Pub. Date: Dec. 1, 2011

(54) TONER AND TONER MANUFACTURING METHOD

(75) Inventors: Kentarou MOGI, Tokyo (JP); Noboru UEDA, Tokyo (JP); Hiroyuki KOZURU, Tokyo (JP)

(73) Assignee: KONICA MINOLTA BUSINESS TECHNOLOGIES, INC., Tokyo (JP)

(21) Appl. No.: 13/113,731

(22) Filed: May 23, 2011

(30) Foreign Application Priority Data
May 31, 2010 (JP) 2010-123886

(51) Int. Cl. G03G 9/08

(52) U.S. Cl. 430/108.22; 430/137.14

(57) ABSTRACT

Disclosed is a toner comprising at least a binder resin, a colorant and a polyurethane resin, wherein the polyurethane resin is a carboxy-denatured polyurethane resin.

### CROSS-REFERENCE TO RELATED APPLICATION

The present U.S. patent application claims a priority under the Paris Convention of Japanese patent application No. 2010-123886 filed on May 31, 2010, which shall be a basis of correction of an incorrect translation.

### BACKGROUND OF THE INVENTION

1. Field of the Invention

The present invention relates to toner and a toner manufacturing method.

2. Description of Related Art

At present, with regard to printed matter by an electrophotographic method, use thereof is becoming diverse and various because of an enhancement of image quality by a diameter reduction of toner, a speed enhancement of a printer, a high-level image processing capability thereof, and the like. For example, print that reproduces photograph image quality, package printing and the like are mentioned. In particular, in the package printing, since the electrophotography has a high ability to respond to the on-demand printing, the printed matter by the electrophotographic method has an advantage that a design can be printed on the scene, and is capable of responding to the flexible production. Accordingly, the printer matter by the electrophotographic method can be preferably used.

As a method of enhancing image strength such as abrasion resistance and folding resistance, for example, an image is proposed, which is strong against folding by determining a component of binder resin and a quantity thereof (for example, refer to Japanese Patent Laid-Open Publication No. H08-62894). Moreover, there is proposed a method of determining an insoluble amount of tetrahydrofuran and a quantity of liquid paraffin in toner by containing vinyl resin and polyester resin in addition to the binder resin (for example, refer to Japanese Patent Laid-Open Publication No. 1111-305479).

Moreover, there is proposed a method of determining a glass transition temperature (Tg) and softening point of the toner, by containing a binder resin, a colorant, and polybutadiene (for example, refer to Japanese Patent Laid-Open Publication No. 2007-133308).

Furthermore, there are proposed: a method of determining a resin configuration in the toner and molecular weights of the respective resins therein, and further using Fischer-Tropsch wax (for example, refer to Japanese Patent Laid-Open Publication No. H07-271084); and toner in which methanol wettability is determined (for example, refer to Japanese Patent Laid-Open Publication No. 2007-248666).

However, in comparison with printed matter by the offset printing and the gravure printing, in the printed matter by the electrophotographic method, the image strength thereof is weak, and many thereof has been unsuitable to be processed.

In the usual package printing, the printed matter is processed frequently, and it has been unsuitable to adopt the electrophotographic method in such a case. For example, a fancy box, wrapping paper, a design envelope and the like are frequently subjected to folding, cutting, punching and the like, and moreover, thick paper is used for the fancy box and the like. Accordingly, particularly in the case where the printed matter is folded, defects and losses are prone to occur in the printed image. Moreover, in the case of the thick paper, a stretched quantity of a folded surface thereof when the thick paper concerned is folded is increased more than in the case of thin paper, whereby the defects and the losses are prone to occur.

Moreover, the toner containing the conventional binder resin is sometimes incapable of holding sufficient strength against the folding when the printing is performed for the thick paper, and has not obtained sufficient strength for the abrasion resistance of the surface of the thick paper concerned. Moreover, the toner added with the liquid paraffin and wax is prone to strongly affect the resistance concerned depending on the temperature, is fragile and prone to be broken, and accordingly, sometimes adversely affects the folding. Moreover, in the case of using toner containing polybutadiene, it is insufficient to uniformize the image after fixation, and sufficient strength cannot sometimes be obtained. Fixing properties brought by the wettability of the toner are advantageous in uniformizing the fixed image; however, in such a situation where the image is stretched as in the folding of the thick paper, a crack sometimes occurs. Hence, toner has been desired, which can obtain an image that is good in the image strength and the abrasion resistance of the image surface at the time of the folding.

Accordingly, a method of containing, in the toner, urethane particles with a particle diameter ranging from 0.5 μm to 4.0 μm is proposed (for example, Japanese Patent Laid-Open Publication No. 2009-198972).

However, in the case of the toner described in Japanese Patent Laid-Open Publication No. 2009-198972 described above, the particle diameter of the urethane particles for use is large, and accordingly, irregularities of surfaces of the toner are large. The toner has a problem that a decrease of a gloss is consequently brought about.

### SUMMARY OF THE INVENTION

The present invention has been made in consideration of the above-described circumstances. It is an object of the present invention to provide toner excellent in blocking resistance and a method for producing the toner in such a manner that fold fixing performance is enhanced without bringing about the gloss decrease.

To achieve at least one of the abovementioned objects, a toner reflecting one aspect of the present invention comprises: at least a binder resin, a colorant and a polyurethane resin,

wherein the polyurethane resin is a carboxy-denatured polyurethane resin.

To achieve at least one of the abovementioned objects, a method of producing a toner containing at least a binder resin, a colorant and a polyurethane resin, reflecting another aspect of the present invention comprises the steps of:

1) reacting at least one compound selected from following (a) with the polyurethane resin having an isocyanate radical in a molecular chain, and preparing a carboxy-denatured polyurethane resin, wherein

(a) a multivalent carboxylic acid, a hydroxyl-carboxylic acid compound;

2) dispersing the carboxy-denatured polyurethane resin within a range where a volume reference median diameter is 100 to 500 nm, and preparing a carboxy-denatured polyurethane resin fine particle dispersion; and

3) mixing a binder resin fine particle dispersion with a volume reference median diameter of 60 to 500 nm, the carboxy-denatured polyurethane resin fine particle dispersion and a colorant dispersion with one another, aggregating binder resin fine particles, carboxy-denatured polyurethane resin fine particles and colorant particles in an aqueous medium, and forming toner particles.

### BRIEF DESCRIPTION OF THE DRAWINGS

The present invention will become more fully understood from the detailed description given hereinbelow and the appended drawings, and thus are not intended as a definition of the limits of the present invention, wherein;

FIG. 1 shows Table 1;

FIG. 2A shows Table 2A; and

FIG. 2B shows Table 2B.

### DESCRIPTION OF THE PREFERRED EMBODIMENTS

A description is made below of toner according to the present invention.

### [Toner]

The toner of the present invention at least contains binder resin, colorant and acid-denatured polyurethane resin.

Then, preferably, the acid-denatured polyurethane resin is carboxy-denatured polyurethane resin reacted with at least one or more compounds selected from the following (a) since advantages in fold fixing properties and a gloss level are brought about. Besides (a), amino-carboxylic acid as a representative of amino acids can also be used.

(a) Multivalent Carboxylic Acid, Hydroxyl-Carboxylic Acid Compound

Moreover, preferably, a content of the carboxy-denatured polyurethane resin in the toner is 3 to 15 parts by mass. The reason why the content is set at 3 to 15 parts by mass is as follows. This is because, when the content exceeds 15 parts by mass, thermoplasticity of the toner is decreased, and accordingly, it is apprehended that fixing strength of the toner and a gloss of an image may be decreased. The polyurethane resin is locally present in the toner, and at the time of fixing the toner, clusters of the polyurethane resin more insoluble than the binder resin form irregularities on each surface of the toner, resulting in the decrease of the gloss.

Meanwhile, when the content is less than 3 parts by mass, it is apprehended that an effect of the fold fixing properties may become in sufficient.

Moreover, preferably, the number of isocyanate radicals remaining in the carboxy-denatured polyurethane resin is 0.5% or less with respect to the number of all isocyanate radicals in an isocyanate compound required to synthesize the polyurethane resin.

This is because, when a large number of unreacted isocyanate radicals which have high reactivity remain in the carboxy-denatured polyurethane resin (that is, when the number of residual isocyanate radicals is larger than 0.5%), particles of the toner aggregate by the elapse of time, and it is apprehended that a deterioration of blocking resistance may be brought about.

Here, a description is made of determination of the number of isocyanate radicals remaining in the carboxy-denatured polyurethane resin.

The “isocyanate radicals” refer to —N═C═O radicals. The isocyanate radicals can be determined in such a manner that 0.1 g of polyurethane is added and dissolved into 40 ml of a dimethylformamide solution of 0.01 normality di-n-butylamine, and thereafter, neutralization titration is performed by a methanol solution of 0.01 normality hydrochloric acid by using bromphenol blue as an indicator.

Moreover, preferably, the carboxy-denatured polyurethane resin is contained by 5 to 25 mgKOH/g from a viewpoint of being uniformly dispersed in the binder resin of the toner particles.

### (Polyurethane Resin)

The polyurethane resin refers to a polymer compound in which a polymer dial segment and a diisocyanate compound are subjected to urethane bonding.

Polyurethane is a polymer composed of: a hard segment formed of diisocyanate and low-molecular-weight diol; and a soft segment formed of the polymer diol segment. As polymer diol that gives the soft segment, there are those of polyether, polyester, polyolefin, polycarbonate and the like.

Such urethane resin for use in the present invention is not particularly limited. However, for example, there is mentioned: a urethane polymer obtained by reacting (i) a component containing two or more pieces of active hydrogen in one molecule on the average and (ii) a multivalent isocyanate component with each other; or a urethane polymer obtained by reacting, with a chain extender such as diol, an isocyanate radical-containing prepolymer obtained by reacting the above-described (i) component and (ii) component with each other under a condition where the isocyanate radicals are excessive.

Note that a chain extension method of the isocyanate radical-containing prepolymer just needs to be one known in public. For example, it is sufficient if water, water-soluble polyamine, glycols and the like are used as the chain extender, and if the isocyanate radical-containing prepolymer and a component of the chain extender are reacted with each other under the presence of catalyst according to needs.

The (i) component containing two or more pieces of the active hydrogen in one molecule on the average is not particularly limited; however, a component containing hydroxyl active hydrogen is preferable. As specific examples of the compound as described above, those as below are mentioned.

(1) Diol compound: ethylene glycol, propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexane glycol, 2,5-hexanediol, dipropylene glycol, 2,2,4-trimethyl-1,3-pentanediol, tricyclodecane dimethanol, 1,4-cyclohexane dimethanol, and the like.
(2) Polyether diol: an alkylene oxide adduct of the diol compound, and a ring-opening (co)polymer of alkylene oxide or cyclic ether (tetrahydrofuran or the like), for example, polyethylene glycol, polypropylene glycol, a (block or random) copolymer of ethylene glycol and propylene glycol, glycol, polytetramethylene glycol, polyhexamethylene glycol, polyoctamethylene glycol, and the like.
(3) Polyester diol: mentioned is one obtained by performing polycondensation for dicarboxylic acid (anhydride) and the dial compound mentioned in the above-described (1) under a condition where hydroxyl radicals are excessive, in which the dicarboxylic acid is adipic acid, succinic acid, sebacic acid, glutaric acid, maleic acid, fumaric acid, phthalic acid and the like, and the diol compound is ethylene glycol, propylene glycol, 1,4-butanediol, 1,6-hexanediol, 1,8-octamethylenediol, neopentyl glycol, and the like. Specifically, there can be illustrated an ethylene glycol-adipic acid condensate, a butanediol-adipic acid condensate, a hexamethylene glycol-adipic acid condensate, an ethylene glycol-propylene glycol-adipic acid condensate, polylactonediol in which lactone is subjected to ring-opening polymerization by using glycol as an initiator, or the like.
(4) Polyether ester diol: ether radical-containing diol (polyether diol, diethylene glycol and the like in the above-described (2)), or one obtained by adding a mixture of this ether radical-containing diol and another glycol to (anhydride) dicarboxylic acid as illustrated in the above-described (3) and reacting a resultant with alkylene oxide, for example, a polytetramethylene glycol-adipic acid condensate and the like.
(5) Polycarbonate diol: compounds represented by a general formula HO—R—(O—C(O)—O—R)x-OH (where R is a saturated aliphatic acid diol residue with a carbon atom number of 1 to 12, and x is the number of molecule repeating units, and is usually an integer of 5 to 50), and the like. These can be obtained by an ester exchange method of reacting saturated aliphatic diol and substituted carbonate (diethyl carbonate, diphenyl carbonate and the like) with each other under the condition where the hydroxyl radicals are excessive, a method of reacting the saturated aliphatic dial and phosgene with each other, or thereafter, further reacting saturated aliphatic dial therewith according to needs, and the like.

The compounds as illustrated in the above-described (1) to (5) can be used singly or by combining two or more thereof with one another.

As the (ii) multivalent isocyanate component reacted with the above-described (i) component, an aliphatic, cycloaliphatic or aromatic compound containing two or more isocyanate radicals in one molecule on the average can be used.

As an aliphatic diisocyanate compound, aliphatic diisocyanate with a carbon atom number of 1 to 12 is preferable, and for example, there are mentioned hexamethylene diisocyanate, 2,2,4-trimethylhexane diisocyanate, and the like. As a cycloaliphatic diisocyanate compound, cycloaliphatic diisocyanate with a carbon atom number of 4 to 18 is preferable, and for example, there are mentioned 1,4-cyclohexane diisocyanate, methylcyclohexylene diisocyanate, and the like. As aromatic isocyanate, there are mentioned tolylene diisocyanate, 4,4′-diphenylmethane diisocyanate, xylylene diisocyanate, and the like.

A description is made below of the multivalent carboxylic acid and the hydroxyl-carboxylic acid, which are capable of forming the acid-denatured polyurethane resin by allowing reaction thereof with polyurethane resin.

### (Multivalent Carboxylic Acid)

As dibasic acid, there are mentioned succinic acid, maleic acid, fumaric acid, itaconic acid, azelaic acid, mesaconic acid, citraconic acid, sebacic acid, glutaconic acid, adipic acid, malonic acid, phthalic acid, isophthalic acid, terephthalic acid, cyclohexane dicarboxylic acid, nadic acid, methylnadic acid, octylsuccinic acid, dodecenylsuccinic acid and the like, and anhydrides and lower alkyl (methyl, ethyl) esters of these acids, and the like. Besides, polymerized aliphatic acid such as a dimer and trimer of linoleic acid can also be used. The dibasic acid can be used singly or as a mixture of two or more of the above.

Among them, alkyl or alkenyl (carbon number: 4 to 18) succinic acid represented by succinic acid, maleic acid, fumaric acid, phthalic acid, isophthalic acid, terephthalic acid, octylphthalic acid and dodecenylsuccinic acid is preferable. Succinic acid is particularly preferable.

Such a polycondensation reaction can use a catalyst (for example, dibutyl tin oxide, tin protoxide and tetrabutyl titanate) according to needs, and in usual, can be performed at an arbitrary temperature of 150 to 300° C. Moreover, this reaction can be performed under normal pressure or reduced pressure, and further, under the presence or absence of inert gas and a solvent. Furthermore, in order to reduce a quantity of end hydroxyl radicals of polyester, and to increase a quantity of carboxylic radicals thereof, a reaction of acid anhydride can also be allowed after the polycondensation reaction. Succinic anhydride is preferable as the acid anhydride; however, the acid anhydride is not limited to this as long as the acid anhydride is any anhydride of the above-described dibasic acids.

### (Hydroxyl-Carboxylic Acid)

As the hydroxyl-carboxylic acid, there are mentioned methylol alkanoate (methylol acetate, methylol propionate, dimethylol butyrate), dimethylol alkanoate (dimethylol acetate, dimethylol propionate, dimethylol butyrate), trimethylol alkanoate (trimethylol acetate, trimethylol propionate, trimethylol butyrate), aliphatic hydroxycarboxylic acid (glycol acid, lactic acid, hydroxybutyric acid and the like), aromatic hydroxycarboxylic acid (salicylic acid, cresylic acid, mandelic acid, vanillic acid, syringic acid and the like), or mixtures of these. Dimethylol acetate is particularly preferable from a viewpoint of reactivity.

A description is made below of the main binder resin for use in combination with the acid-denatured polyurethane resin of the present invention.

### [Binder Resin]

As the binder resin of the toner of the present invention, styrene-acrylic resin is preferably used since an effect of adding the acid-denatured polyurethane resin thereto is significant. Specifically, as the styrene-acrylic resin, a random copolymer by monomers at least including a styrene monomer and an acrylic acid monomer is mentioned.

As the styrene monomer, for example, there are mentioned styrene and styrene derivatives such as o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene. These can be used singly or by combining two or more thereof with one another.

Moreover, as the acrylic acid monomer, there are mentioned: methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylic acid ester derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and the like. These can be used singly or by combining two or more thereof with one another.

Among them, styrene, butyl acrylate and methyl methacrylate are particularly preferable from viewpoints of versatility and copolymerization properties, and desirably, a copolymerization ratio of the styrene monomer is 60% by mass or more and 80% by mass or less.

Preferably, an acid value of the binder resin described above is 5 to 30 mgKOH/g.

The acid value of the binder resin is within the above-described range, whereby the acid-denatured polyurethane resin can be uniformly dispersed in the toner particles. Meanwhile, in the case where the acid value of the binder resin is less than 5 mgKOH/g, an interaction of the binder resin with the acid-denatured polyurethane resin becomes insufficient. Accordingly, the acid-denatured polyurethane resin cannot be uniformly dispersed in the toner particles. On the other hand, in the case where the acid value of the binder resin exceeds 30 mgKOH/g, an interaction among pieces of the main resin is too strong, and accordingly, the acid-denatured polyurethane resin cannot be easily dispersed in the main resin.

Furthermore, the binder resin can be formed to have a crosslinking structure by using polyfunctional vinyls such as divinyl benzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

### (Polyester Binder Resin)

Polyester resin is also preferably used as the binder resin of the toner of the present invention.

The polyester resin is synthesized by a condensation reaction of an acid (dicarboxylic acid) component and an alcohol (dial) component. In the following, an “acid-derived constituent component” refers to a constituent region that used to be the acid component before the synthesis of the polyester resin, and an “alcohol-derived constituent component” refers to a constituent region that used to an alcohol component before the synthesis of the polyester resin.

### <<Acid-Derived Constituent Component>>

As the acid-derived constituent component, aliphatic dicarboxylic acid is desirable, and particularly, straight-chain carboxylic acid is desirable. As the straight-chain carboxylic acid, for example, there are mentioned oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecane dicarboxylic acid, 1,12-dodecane dicarboxylic acid, 1,13-tridecane dicarboxylic acid, 1,14-tetradecane dicarboxylic acid, 1,16-hexadecane dicarboxylic acid, 1,18-octadecane dicarboxylic acid, and the like, or lower alkyl esters and acid anhydrides thereof.

Other monomers are not particularly limited, and for example, there are mentioned divalent carboxylic acids and divalent alcohols, which are heretofore known in public and are monomer components as written in “Ko-bunshi (polymer) data handbook: kiso-hen (basic volume)” (edited by The Society of Polymer Science, Japan: Baifukan Co., Ltd.). With regard to specific examples of these monomer components, as the divalent carboxylic acids, for example, there are mentioned dibasic acid such as phthalic acid, isophthalic acid, terephthalic acid, naphthalene-2,6-dicarboxylic acid, naphthalene-2,7-dicarboxylic acid, and cyclohexane dicarboxylic acid, anhydrides of these, lower alkyl esters of these and the like. These may be used singly, or two or more thereof may be used in combination.

Besides the above-mentioned aliphatic dicarboxylic acid-derived constituent component, it is preferable that a constituent component such as a dicarboxylic acid-derived constituent component having a sulfa radical be contained as the acid-derived constituent component.

The above-described carboxylic acid having the sulfo radical is effective in that dispersion of a coloring material such as pigment can be performed satisfactorily. Moreover, in the event of preparing mother particles of the toner by emulsifying or suspending the whole of the resin into water, if the sulfo radical is present, then it is possible to emulsify or suspend the resin without using surfactant as will be described later. As the dicarboxylic acid having the sulfa radical as described above, for example, there are mentioned 2-sulfoterephthalic acid sodium salt, 5-sulfoisophthalic acid sodium salt, sulfosuccinic acid sodium salt and the like; however, the dicarboxylic acid having the sulfa radical is not limited to these. Moreover, lower alkyl esters, acid anhydrides and the like of those described above are also mentioned. Among them, the 5-sulfoisophthalic acid sodium salt and the like are preferable in terms of cost. Preferably, a content of the dicarboxylic acid having the sulfo radical is 0.1 mol % or more to 2.0 mol % or less, and particularly preferably, is 0.2 mol % or more to 1.0 mol % or less. When the content is more than 2 mol %, chargeability of the toner is deteriorated. Note that such a “constituent mol %” as described above refers to a percentage when each of the respective constituent components (acid-derived constituent component, alcohol-derived constituent component) in the polyester resin is defined at 1 unit (mol).

### <<Alcohol-Derived Constituent Component>>

As the alcohol-derived constituent component, aliphatic dialcohol is desirable. For example, there are mentioned ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-dodecanediol, 1,12-undecanediol, 1,13-tridecanediol, 1,14-tetradecanediol, 1,18-octadecanediol, 1,20-eicosanediol, and the like.

As other divalent dialcohols, for example, there are mentioned bisphenol A, hydrogen-added bisphenol A, ethylene oxide or (and) propylene oxide adduct of bisphenol A, 1,4-cyclohexanediol, 1,4-cyclohexanedimethanol, diethylene glycol, propylene glycol, dipropylene glycol, 1,3-butanediol, neopentyl glycol, and the like. These may be used singly, or two or more thereof may be used in combination.

### (Colorant)

As the colorant for use in the present invention, inorganic or organic colorant known in public can be used. Specific colorants are shown below.

As black colorant, for example, there is used carbon black such as furnace black, channel black, acetylene black, thermal black and lamp black. Moreover, magnetic powder of magnetite, ferrite or the like is also used.

Moreover, as colorant for magenta or red, there are mentioned C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and the like.

Moreover, as colorant for orange or yellow, there are mentioned C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 74, C.I. Pigment Yellow 93, C.I. Pigment Yellow 94, C.I. Pigment Yellow 138, and the like.

Furthermore, as colorant for green or cyan, there are mentioned C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66, C.I. Pigment Green 7, and the like.

### (Release Agent)

As wax (release agent) usable for the toner of the present invention, those heretofore known in public are mentioned, and specifically, those listed below are mentioned.

### (1) Hydrocarbon wax

### (2) Ester wax

### (3) Amide wax

Ethylene diamine dibehenyl amide, trimellitic acid tristearyl amide, and the like

(4) Dialkyl ketone wax

Distearyl ketone, and the like

### (5) Others

Carnauba wax, montan wax, and the like

### (Others)

The toner in the present invention may use a charge control agent, an external additive and the like according to needs.

As the charge control agent, there are mentioned nigrosine dye, metal salt of naphthenic acid or higher fatty acid, alkoxylated amine, quaternary ammonium chloride, azo metal complex, salicylic acid metal salt or a metal complex thereof, and the like. Metal contained in the charge control agent may be Al, B, Ti, Fe, Co, Ni and the like. A metal complex compound of a benzilic acid derivative is particularly preferable as the charge control agent.

Besides hydrophobic silica and hydrophobic metal oxide, which are known in public, cerium oxide particles or higher alcohol particles with a carbon number of 20 to 50 are preferable to be added as the external additive from a viewpoint of enhancing filming resistance. In the case of adding the cerium oxide particles, it is preferable to use those with a number average particle diameter of 150 to 800 nm from a viewpoint of enhancing filming resistance, and it is more preferable to use those with a number average particle diameter of 250 to 700 nm. Moreover, preferably, an additional amount of the cerium oxide particles is set at 0.5 to 3.5% by mass with respect to the toner. By setting the additional amount within a range of 0.5 to 3.5% by mass, a good cleaning capability is maintained, and an effect of the filming resistance can be stably obtained. Moreover, in the case where the additional amount is excessive, adhesive force of the toner particles molten at the time of heating and fixing is suppressed, and fixing strength of the toner particles is decreased; however, there does not occur such a problem of the decrease of the fixing strength by setting the additional amount within the above-described range.

Moreover, in the case of adding the higher alcohol particles with a carbon number of 20 to 50, it is preferable that a peak of a carbon number distribution of the alcohol particles stay within a range of 20 to 45 though some alcohol particles with a different carbon number may be mixed thereinto. Moreover, in the higher alcohol particles, it is preferable that a straight-chain component thereof stay within a range of 75 to 98%. Furthermore, it is preferable that a median diameter as a number reference of the higher alcohol be 200 nm or more to 800 nm or less from the viewpoint of the filming resistance.

### [Production Method of Toner]

Next, a description is made of a method for producing the toner of the present invention.

The toner according to the present invention can be produced by a publicly known method such as a pulverization method, a suspension polymerization method and an emulsion polymerization aggregation method.

As a preferred example of the production method of the toner according to the present invention, a description is made below of the production method of the toner, which is based on the emulsion polymerization aggregation method. The production method of the toner is composed of:

(1) the step of reacting at least one or more compounds selected from the following (a) with polyurethane resin having an isocyanate radical in a molecular chain thereof, and preparing carboxy-denatured polyurethane resin;

(a) multivalent carboxylic acid, hydroxyl-carboxylic acid compound

(2) the step of dispersing the carboxy-denatured polyurethane resin into an aqueous medium within a range where a volume reference median diameter is 100 to 500 nm, and preparing a carboxy-denatured polyurethane resin fine particle dispersion;
(3) the step of dispersing binder resin in an aqueous medium within a range where a volume reference median diameter is 60 to 500 nm, and preparing a binder resin fine particle dispersion;
(4) the colorant particle dispersing step of dispersing colorant in an aqueous medium;
(5) the salt precipitation, aggregation and fusion step of mixing the binder resin fine particle dispersion, the carboxy-denatured polyurethane resin dispersion and the colorant dispersion with one another, performing salt precipitation, aggregation and fusion for these, and forming toner particles;
(6) the filtration and washing step of performing filtration and obtaining (aqueous medium) toner particles from a disperse system of the toner particles, and removing surfactant and the like from the toner particles concerned;
(7) the drying step of drying the toner particles subjected to the washing treatment; and
(8) the step of adding an external additive to the toner particles subjected to the drying treatment.

Specific examples of the respective steps are shown below.

(1) The Step of Reacting at Least One or More Compounds Selected from the Following (a) with Polyurethane Resin Having an Isocyanate Radical in a Molecular Chain Thereof, and Preparing Carboxy-Denatured Polyurethane Resin

(a) multivalent carboxylic acid, hydroxyl-carboxylic acid compound

Polymer diol and a diisocyanate compound are reacted with each other to form urethane, whereby the polyurethane resin is adjusted, and thereafter, the multivalent carboxylic acid or the hydroxyl-carboxylic acid compound is added and reacted therewith in order to denature the unreacted isocyanate radicals to carboxylic acid. Thereafter, a solvent is eliminated from a resultant, and the carboxy-denatured polyurethane resin is prepared.

(2) The Step of Dispersing the Carboxy-Denatured Polyurethane Resin within a Range where a Volume Reference Median Diameter is 100 to 500 nm, and Preparing a Carboxy-Denatured Polyurethane Resin Fine Particle Dispersion

The prepared carboxy-denatured polyurethane resin is added to an aqueous medium, and subjected to dispersion treatment by a dispersing machine, and a dispersion is prepared, in which the carboxy-denatured polyurethane resin is dispersed in a fine particle state.

Here, the reason why the carboxy-denatured polyurethane resin is dispersed within the range where the volume reference median diameter is 100 to 500 nm is that aggregation easiness of the urethane resin depends on the particle diameter thereof. Specific reasons are as follows. When the particle diameter of the urethane resin dispersion becomes 500 nm or more, it is difficult for the polyurethane resin to aggregate, and when the particle diameter of the urethane resin is set at 100 nm or less, particles of the urethane resin cause homoaggregation. In both of the cases where the particle diameter is large and small, the urethane resin becomes locally present in the toner. When the urethane resin is locally present in the toner, it becomes impossible to exert the maximum effect in terms of imparting flexibility to the image. Moreover, when the particle diameter becomes 500 nm or more, irregularities become prone to be formed on the surface of the image, and as a result, the gloss of the toner surface is decreased. From a similar viewpoint, a particularly preferable range of the volume reference median diameter is 190 to 300 nm.

Here, in order to control the volume reference median diameter of the carboxy-denatured polyurethane resin, a concentration of the surfactant in the aqueous medium may be adjusted within a range of 0.7 times to 3.0 times as much as a critical micelle concentration. Preferably, a temperature of the aqueous medium is 4° C. to 30° C. When Clearmix (made by M Technique Co., Ltd.) is used as a stirrer, a dispersion time can be adjusted within a range of 10 minutes to 120 minutes.

At this time, “undenatured polyurethane resin” can also be subjected to acid-denaturation after being dispersed into the aqueous medium. However, from a viewpoint of productivity, preferably, the acid-denatured polyurethane resin is dispersed into the aqueous medium after being created.

(3) The Step of Dispersing Binder Resin within a Range where a Volume Reference Median Diameter is 60 to 500 nm, and Preparing a Binder Resin Fine Particle Dispersion

A binder resin solution or a monomer of the binder resin is added into the aqueous medium, is subjected to the dispersion treatment by the dispersing machine, and is subjected to solvent elimination and polymerization treatment according to needs, whereby a dispersion is prepared, in which the binder resin is dispersed in the fine particle state.

The volume reference median diameter of the binder resin fine particles can be controlled in a similar way to the acid-denatured urethane resin fine particles.

### (4) The Colorant Particle Dispersing Step

Into an aqueous medium represented by aqueous solutions of ionic surfactant and nonionic surfactant, publicly known colorant is added and is subjected to dispersion treatment by the dispersing machine, and a dispersion of colorant in which the colorant is dispersed in the fine particle state is prepared. The dispersion treatment for the colorant is performed in the aqueous medium in a state where the concentration of the surfactant is set at the critical micelle concentration (CMC) or more. The dispersing machine for use in the dispersion treatment is not particularly limited; however, preferably, there are mentioned: pressure dispersing machines such as an ultrasonic dispersing machine, a mechanical homogenizer, a Manton-Gaulin, a pressure-type homogenizer; and medium-type dispersing machines such as a sand grinder, a Getzmann mill and a diamond fine mill.

With regard to colorant particles in the dispersion, preferably, a median diameter thereof in the volume reference is 40 to 200 nm.

(5) The Salt Precipitation, Aggregation and Fusion Step of Mixing the Binder Resin Fine Particle Dispersion, the Carboxy-Denatured Polyurethane Resin Dispersion and the Colorant Particles with One Another, Performing Salt Precipitation, Aggregation and Fusion for these, and Forming Toner Particles

The dispersion of the colorant particles is added to the above-described binder resin fine particle dispersion and the above-described carboxy-denatured polyurethane resin fine particle dispersion, and according to needs, a dispersion of release agent particles is added thereto. Subsequently, an aggregation agent is added to a mixture. Then, in the aqueous medium, the above-described binder resin particles, the above-described carboxy-denatured polyurethane resin particles, the above-described colorant particles, and further, the added release agent in the case of being added are aggregated and fused, and the toner particles are formed. A serial step of the aggregation and the fusion is sometimes called an association step.

As a method of the aggregation/fusion, a salt precipitation/fusion method is preferable. The salt precipitation/fusion method is a method, in which the aggregation and the fusion are promoted simultaneously, and when aggregated particles grow to a desired particle diameter, an aggregation stopper is added thereto, and the growth of the particles is stopped. In this method, heating for controlling a shape of the particles is continuously performed according to needs.

As a size of the toner particles, 3 to 10 μm is preferable in the median diameter of the volume reference, and 3 to 7 nm is particularly preferable. A volume reference median diameter of core particles is measured and calculated by using an apparatus in which a computer system (made by Beckman Coulter, Inc.) having data processing software “Software V3.51” mounted thereon is connected to Coulter Multisizer 3 (Beckman Coulter, Inc.).

A measurement procedure is described. 0.02 g of a sample is given affinity with 20 ml of a surfactant solution (surfactant solution in which a neutral detergent containing a surfactant component is diluted ten times with pure water for the purpose of dispersing the sample), thereafter, ultrasonic dispersion is performed therefor for one minute, and a dispersion of the sample is prepared. The prepared dispersion is injected by a pipette into a beaker having ISOTON II (made by Beckman Coulter, Inc.) in a sample stand until a display concentration of a measuring instrument becomes 5 to 10%. By setting the concentration within this range, a reproducible measurement value is obtained. In the measuring instrument, the counting number of measured particles is set at 25000, an aperture diameter is set at 50 μm, a range of 1 to 30 μm as a measurement range is divided into 256 sections, and a frequency value in this case is calculated. A particle diameter at 50% in order from where a volume accumulation fraction is larger is defined as the volume reference median diameter.

The above-described aqueous medium refers to one in which a main component (50% by mass or more) is water. As a component other than water, an organic solvent dissolved into water can be mentioned. For example, there are mentioned methanol, ethanol, isopropanol, butanol, acetone, methylethylketone, tetrahydrofuran, and the like.

Note that the toner particles may be subjected to an aging step after the aggregation/fusion step.

Specifically, a heating temperature is set a little lower in the aggregation/fusion step, whereby the promotion of the fusion among the particles is suppressed, and uniformization of the aggregated particles is achieved. Thereafter, in the aging step, the heating temperature is set a little lower, and a heating time is set long, and control is performed so that the surfaces of the toner particles can have a uniform shape.

### (6) The Cooling/Washing Step

In the cooling/washing state, the obtained dispersion of the toner particles is cooled, for example, at a cooling rate of 1 to 20° C./min. When the dispersion is cooled to a predetermined temperature, the toner particles are subjected to solid-liquid separation from the cooled dispersion of the toner particles. Besides a centrifugal separation, the solid-liquid separation may be performed by any method such as reduced-pressure filtration using a funnel and filteration using a filter press, and the like. Subsequently, a toner cake (one in which the wet toner particles are formed into a cake-like cylindrical shape) obtained by the solid-liquid separation is washed, and adherend such as the surfactant and the salt precipitation agent is removed.

### (7) The Drying Step

In the drying step, the washed toner cake is subjected to the drying treatment. For the drying step, a spray dryer, a vacuum freeze dryer, a reduced-pressure dryer and the like can be used. Moisture in the dried toner particles is preferably 5% by mass or less, and more preferably, 2% by mass or less.

### (8) The External Additive Addition Step

In the external additive addition step, the external additive is mixed into the toner particles obtained by the drying, and toner for electrostatic charge development is obtained.

### [Preparation of Developer]

For the toner of the present invention, for example, such cases are conceived where the toner concerned is used as one-component magnetic toner by containing a magnetic material therein, where the toner is used as a two-component developer by being mixed with a so-called carrier, and where nonmagnetic toner is singly used. The toner can be suitably used in any of the cases.

In the toner of the present invention, in the case where the toner is used as the two-component developer mixed with the carrier, an occurrence of the toner filming (carrier contamination) to the carrier can be suppressed, and in the case where the toner is used as the one-component developer, an occurrence of the toner filming to a frictional electrification member of a developing device can be suppressed.

As the carrier that composes the two-component developer, magnetic particles can be used, which are composed of such materials heretofore known in public as metal including iron, ferrite, magnetite and the like, and alloys of these metals and metal including aluminum, lead and the like. It is particularly preferable to use ferrite particles.

As the carrier, one in which a volume average particle diameter is 15 to 100 μm is preferable, and one in which the volume average particle diameter is 25 to 60 μm is more preferable. The volume average particle diameter can be typically measured by a laser diffraction-type particle size distribution measuring device “HELOS” (made by Sympatec GmbH) provided with a wet dispersing machine.

As the carrier, it is preferable to use one further coated with resin, or a so-called resin dispersion-type carrier in which magnetic particles are dispersed into resin. A composition of the resin for the coating is not particularly limited. However, for example, olefin resin, styrene resin, styrene-acrylic resin, silicon resin, ester resin, fluorine-containing polymer resin or the like is used. Moreover, the resin for composing the resin dispersion-type carrier is not particularly limited, and those known in public can be used. For example, styrene-acrylic resin, polyester resin, fluorine resin, phenol resin and the like can be used.

### [Image Forming Method]

The toner described above can be suitably used for an image forming method including a fixing step according to a contact heating mode. In the image forming method, specifically, by using the toner as described above, for example, an electrostatic latent image formed electrostatically on an image carrier is made visible in such a manner that the developer is charged by the frictional electrification member in the developing device, whereby a toner image is obtained. Then, this toner image is transferred onto a sheet, and thereafter, the toner image transferred onto the sheet is fixed to the sheet by fixing treatment according to the contact heating mode, whereby a visible image is obtained.

### [Fixing Method]

As a suitable fixing method using the toner of the present invention, one according to the so-called contact heating mode can be mentioned. As the contact heating mode, there can be mentioned particularly a hot-press fixing mode, and further, a heated roll fixing mode and a pressure-heating fixing mode of fixing the image by a rotating pressurization member that contains therein a fixedly arranged heating body.

In the fixing method according to the heated roll fixing mode, in usual, a fixing device is used, which is composed of: an upper roller in which a heat source is provided in an inside of a metal cylinder that has a surface coated with fluorine resin and the like and is formed of iron, aluminum and the like; and a lower roller formed of silicon rubber and the like.

As the heat source, a linear heater is used, and by the heater, the upper roller is heated to approximately 120 to 200° C. as a surface temperature thereof. A pressure is applied between the upper roller and the lower roller, and by this pressure, the lower roller is deformed, whereby a so-called nip is formed on such a deformed portion. A width of the nip is 1 to 10 mm, preferably, 1.5 to 7 mm. Preferably, fixing linear velocity is set at 40 mm/sec to 600 mm/sec. In the case where the width of the nip is too small, it becomes impossible to uniformly apply heat to the toner, sometimes resulting in an occurrence of fixing unevenness. Meanwhile, in the case where the width of the nip is too large, fusion of the polyester resin contained in the toner particles is accelerated, sometimes resulting in an occurrence of fixing offset.

### EXAMPLES

A description is made below of specific examples of the present invention; however, the present invention is not limited to these.

### (1) The Step of Preparing Carboxy-Denatured Polyurethane Resin

<Example of Synthesizing Carboxy-Denatured Polyurethane Resin Fine Particles (i)/Multivalent Carboxylic Acid is Used>

In methylethylketone, 1000 parts by mass of isophorone diisocyanate and 830 parts by mass of 1,4-adipate (polyester diol made of 1,4-butanediol and adipic acid) were reacted with each other at 80° C. for 6 hours, and urethane was formed.

Thereafter, in order to denature the unreacted isocyanate radicals to the carboxylic acid, 10 parts by mass of succinic acid was added to the formed urethane, and was reacted therewith at 80° C. for 1 hour.

Next, while such a resultant was being stirred, 2128 parts by mass of ion exchange water was added thereto, thereafter, a pressure in a reaction system was reduced to eliminate the solvent, and 1270 parts by mass of the carboxy-denatured polyurethane resin fine particles (i) was obtained. As a result of analysis, the number of residual isocyanate radicals was 0.2%.

<Example of Synthesizing Carboxy-Denatured Polyurethane Resin Fine Particles (ii)/Hydroxyl-Carboxylic Acid is Used>

In methylethylketone, 1000 parts by mass of hexamethylene diisocyanate and 830 parts by mass of polyethylene glycol were reacted with each other at 80° C. for 6 hours, and urethane was formed.

Thereafter, in order to denature the unreacted isocyanate radicals to the carboxylic acid, 25 parts by mass of dimethylol acetate was added to the formed urethane, and was reacted therewith at 80° C. for 1 hour.

Next, while such a resultant was being stirred strongly, 2128 parts by mass of ion exchange water was added thereto, thereafter, a pressure in a reaction system was reduced to eliminate the solvent, and 1270 parts by mass of the carboxy-denatured polyurethane resin fine particles (ii) was obtained. As a result of analysis, the number of residual isocyanate radicals was 0.15%.

<Example of Synthesizing Carboxy-Denatured Polyurethane Resin Fine Particles (iii)/Multivalent Carboxylic Acid is Used>

In methylethylketone, 1000 parts by mass of 1,4 cyclohexane diisocyanate and 830 parts by mass of ethylene glycol were reacted with each other at 80° C. for 6 hours, and urethane was formed.

Thereafter, in order to denature the unreacted isocyanate radicals to the carboxylic acid, 15 parts by mass of maleic acid was added to the formed urethane, and was reacted therewith at 80° C. for 1 hour.

Next, while such a resultant was being stirred strongly, 2128 parts by mass of ion exchange water was added thereto, thereafter, a pressure in a reaction system was reduced to eliminate the solvent, and 1270 parts by mass of the carboxy-denatured polyurethane resin fine particles (iii) was obtained. As a result of analysis, the number of residual isocyanate radicals was 0.20%.

<Example of Synthesizing Carboxy-Denatured Polyurethane Resin Fine Particles (iv)/Multivalent Carboxylic Acid is Used>

In methylethylketone, 1000 parts by mass of 1,4 cyclohexane diisocyanate and 830 parts by mass of ethylene glycol were reacted with each other at 80° C. for 6 hours, and urethane was formed.

Thereafter, in order to denature the unreacted isocyanate radicals to the carboxylic acid, 2 parts by mass of maleic acid was added to the formed urethane, and was reacted therewith at 80° C. for 1 hour.

Next, while such a resultant was being stirred strongly, 2128 parts by mass of ion exchange water was added thereto, thereafter, a pressure in a reaction system was reduced to eliminate the solvent, and 1270 parts by mass of the carboxy-denatured polyurethane resin fine particles (iv) was obtained. As a result of analysis, the number of residual isocyanate radicals was 1.3%.

<Example of Synthesizing Carboxy-Denatured Polyurethane Resin Fine Particles (v)/Multivalent Carboxylic Acid is Used>

In a similar way to the example of synthesizing the carboxy-denatured polyurethane resin fine particles (iv) except that 2 parts by mass of the maleic acid was changed to 40 parts by mass thereof, 1270 parts by mass of the carboxy-denatured polyurethane resin fine particles (v) was obtained. As a result of analysis, the number of residual isocyanate radicals was 0.1%.

### (2) The Step of Preparing a Carboxy-Denatured Polyurethane Resin Fine Particle Dispersion

<Preparation of a Carboxy-Denatured Polyurethane Resin Fine Particle Dispersion (i)>

| | |
|---|---|
| The carboxy-denatured polyurethane resin particles | 400 parts by mass |
| (i) | |
| Sodium laurylether sulfate (active ingredient: 27%) | 20 parts by mass |
| Ion exchange water | 1580 parts by mass |

By using the mechanical dispersing machine “Clearmix (made by M Technique Co., Ltd.) having a circulation route, the above-described components were mixed and dispersed for 30 minutes, and were thereby sufficiently stirred and dispersed, whereby a water dispersion of solid-concentration polyurethane resin was prepared. A dispersion diameter of the polyurethane particles, which was measured by “Microtrack Particle Size Analyzer UPA150” (made by Nikkiso Co., Ltd.), was 470 nm.

<Preparation of a Carboxy-Denatured Polyurethane Resin Fine Particle Dispersion (ii)>

In a similar way to the preparation of the carboxy-denatured polyurethane resin fine particle dispersion (i) except that the time of mixing and dispersing the components by using the mechanical dispersing machine “Clearmix” (made by M Technique Co., Ltd.) was extended to 60 minutes, a carboxy-denatured polyurethane resin fine particle dispersion (ii) was prepared. An obtained dispersion diameter was 300 nm.

<Preparation of a Carboxy-Denatured Polyurethane Resin Fine Particle Dispersion (iii)>

In a similar way to the preparation of the carboxy-denatured polyurethane resin fine particle dispersion (ii) except that the carboxy-denatured polyurethane resin particles (i) were changed to the carboxy-denatured polyurethane resin fine particles (ii), a carboxy-denatured polyurethane resin fine particle dispersion (iii) was prepared. An obtained dispersion diameter was 470 nm.

<Preparation of a Carboxy-Denatured Polyurethane Resin Fine Particle Dispersion (iv)>

In a similar way to the preparation of the carboxy-denatured polyurethane resin fine particle dispersion (iii) except that the time of dispersing the components by using “Clearmix (made by M Technique Co., Ltd.)” was changed to 90 minutes, a carboxy-denatured polyurethane resin fine particle dispersion (iv) was prepared. A dispersion diameter, which was measured, was 190 nm.

<Preparation of a Carboxy-Denatured Polyurethane Resin Fine Particle Dispersion (v)>

In a similar way to the preparation of the carboxy-denatured polyurethane resin fine particle dispersion (iii) except that the time of dispersing the components by using “Clearmix (made by M Technique Co., Ltd.)” was changed to 60 minutes, a carboxy-denatured polyurethane resin fine particle dispersion (v) was prepared. A dispersion diameter, which was measured, was 300 nm.

<Preparation of a Carboxy-Denatured Polyurethane Resin Fine Particle Dispersion (vi)>

In a similar way to the preparation of the carboxy-denatured polyurethane resin fine particle dispersion (ii) except that the carboxy-denatured polyurethane resin fine particles (ii) were changed to the carboxy-denatured polyurethane resin fine particles (iii), and that the time of dispersing the components by using “Clearmix (made by M Technique Co., Ltd.)” was changed to 20 minutes, a carboxy-denatured polyurethane resin fine particle dispersion (vi) was prepared. A dispersion diameter, which was measured, was 550 nm.

<Preparation of a Carboxy-Denatured Polyurethane Resin Fine Particle Dispersion (vii)>

In a similar way to the preparation of the carboxy-denatured polyurethane resin fine particle dispersion (vi) except that the carboxy-denatured polyurethane resin fine particles (iii) were changed to the carboxy-denatured polyurethane resin fine particles (iv), a carboxy-denatured polyurethane resin fine particle dispersion (vii) was prepared. A dispersion diameter, which was measured, was 300 nm.

<Preparation of a Carboxy-Denatured Polyurethane Resin Fine Particle Dispersion (viii)>

In a similar way to the preparation of the carboxy-denatured polyurethane resin fine particle dispersion (vii) except that the carboxy-denatured polyurethane resin fine particles (iv) were changed to the carboxy-denatured polyurethane resin fine particles (v), a carboxy-denatured polyurethane resin fine particle dispersion (viii) was prepared. A dispersion diameter, which was measured, was 300 nm.

### (3) The Step of Preparing the Binder Resin Fine Particle Dispersion

<Preparation of a Binder Resin Fine Particle Dispersion (i)>

### (Styrene/Acrylic Resin)

Into a reaction container attached with a stirring device, a temperature sensor, a cooling pipe and a nitrogen introduction device, a solution in which 7 parts by mass of sodium polyoxyethylene dodecylether sulfate was dissolved into 800 parts by mass of ion exchange water was poured. The reaction container was heated to 70° C., thereafter, a polymerizable monomer mixed solution obtained by containing compounds shown below was directly added to the poured solution, and an obtained mixture was mixed and dispersed for 1 hour by using the mechanical dispersing machine “Clearmix (made by M Technique Co., Ltd.) having the circulation route, and a dispersion containing emulsified particles (oil droplets) was prepared.

| | |
|---|---|
| styrene | 240 parts by mass |
| n-butylacrylate | 95 parts by mass |
| methacrylic acid | 25 parts by mass |
| polyethylene wax (melting point: 81° C.) | 190 parts by mass |

Subsequently, to this dispersion, there was added a polymerization initiator solution obtained by dissolving 12 parts by mass of potassium persulfate into 230 parts by mass of ion exchange water. Then, an obtained solution was heated to a temperature of 85° C. and stirred for 1 hour to be subjected to polymerization, whereby resin fine particles were obtained.

Moreover, a polymerization initiator solution obtained by dissolving 11 parts by mass of potassium persulfate into 200 parts by mass of ion exchange water was poured into the reaction container, and at a temperature of 82° C., a polymerization monomer solution obtained by containing compounds shown below was dropped thereinto for 1 hour. After such dropping was ended, an obtained mixture was heated and stirred for 2 hours, whereby the polymerization was performed therefor. Thereafter, the mixture was cooled down to 28° C., and a dispersion of the resin fine particles was obtained. This is used as a “binder resin fine particle dispersion (i)”. A dispersion diameter of the obtained “binder resin fine particle dispersion (i)” was 200 nm.

| | |
|---|---|
| styrene | 450 parts by mass |
| n-butylacrylate | 130 parts by mass |
| methacrylic acid | 33 parts by mass |
| n-octyl mercaptan | 8 parts by mass |

<Preparation of a Binder Resin Fine Particle Dispersion (ii)>

### (Polyester Resin)

### (Multivalent Carboxylic Acid Monomer)

terephthalic acid: 7.8 parts by mass; fumaric acid: 17.3 parts by mass; adipic acid: 7.2 parts by mass

### (Multivalent Alcohol Monomer)

2-mol adduct of 2,2-bis(4-hydroxyphenyl)propane propylene oxide: 76 parts by mass
2-mol adduct of 2,2-bis(4-hydroxyphenyl)propane ethylene oxide: 24 parts by mass

Into a flask with an internal capacity of 5 liters, which was provided with a stirring device, a nitrogen introduction pipe, a temperature sensor and a rectifying column, totally 3 parts by mass of the above-described multivalent carboxylic acid monomer and multivalent alcohol component was poured, then these components were heated up to 190° C. for 1 hour, and it was confirmed that an inside of such a reaction system was stirred uniformly. Thereafter, the reaction system was charged with a catalyst Ti(OBu)₄ (0.003% by mass with respect to the total quantity of the multivalent carboxylic acid monomer).

Moreover, while evaporating generated water, such an obtained mixture was heated up to 240° C. from 190° C. for 6 hours, and a dehydration/condensation reaction was further continued for 6 hours at 240° C. to perform polymerization, whereby polyester binder resin particles (ii) were obtained. When a molecular weight of the obtained binder resin particles (ii) was measured by GPC, a weight average molecular weight thereof was 20000, and a number average molecular weight thereof was 2800 (in conversion to a styrene reference material, by HLC-8 120GPC made by Tosoh Corporation).

While being left in a molten state, 100 parts by mass of the binder resin fine particles (ii) obtained as above were transferred to Cavitron CD1010 (made by Eurotech Co., Ltd) at a rate of 100 parts by mass per minute. Into an aqueous medium tank prepared separately, dilute ammonia with a concentration of 0.37% by mass, in which reagent ammonia water is diluted by ion exchange water, was poured. Then, while being heated to 160° C. by a heat exchanger, the diluted ammonia was transferred to Cavitron CD1010 (made by Eurotech Co., Ltd) at a rate of 0.1 liter per minute at the same time when the above-described binder resin fine particles (ii) in the molten state were transferred thereto. Cavitron CD1010 was operated under conditions where a rotation speed of a rotator was 60 Hz, and a pressure was 5 kg/cm². Then, the polyester binder resin fine particle dispersion (ii) was obtained, in which a volume reference median diameter was 297 nm, and a solid content was 30 parts by mass.

<Preparation of a Binder Resin Fine Particle Dispersion (iii)>

### (Styrene/Acrylic Resin)

Similar operations to those of the preparation of the binder resin fine particle dispersion (i) were performed except that 7 parts by mass of “sodium polyoxyethylene dodecylether sulfate” was changed to 3 parts by mass of “sodium polyoxyethylene dodecyl ether sulfate”, and a “binder resin fine particle dispersion (iii)” was obtained. A dispersion diameter of the obtained “binder resin fine particle dispersion (iii)” was 550 nm.

### (4) The Colorant Dispersion Preparation Step

<Preparation of a Colorant Dispersion (i)>

| | |
|---|---|
| Cyan pigment | 10 parts by mass (Pigment Blue 15:3, made by |
| | Dainichiseika Color & Chemicals Mfg. Co., Ltd.) |
| Anionic surfactant | 2 parts by mass (Neogen SC, made by |
| | Dai-Ichi Kogyo Seiyaku Co., Ltd.) |
| Ion exchange water | 80 parts by mass |

The above-described components were mixed with one another, and were dispersed for 1 hour by a high pressure impact-type dispersing machine Ultimizer (HJP30006, made by Sugino Machine Limited), whereby a colorant dispersion (i) with a solid content of 20% was obtained.

<Preparation of a Release Agent (i)>

| | |
|---|---|
| FNP92 (made by Nippon Seiro Co., Ltd.) | 50 parts by mass |
| Anionic surfactant (Dai-Ichi Kogyo Seiyaku | 5 parts by mass |
| Co., Ltd.: Neogen RK) | |
| Ion exchange water | 200 parts by mass |

The above-described components were heated to 110° C., then were dispersed by using a homogenizer (Ultraturrax T50, made by IKA Labortechnik GmbH), and thereafter, were subjected to dispersion treatment by a Manton-Gaulin high pressure homogenizer (made by APV Gaulin GmbH). Then, a release agent, in which an average particle diameter was 0.24 μm, and a melting point was 92° C., was dispersed, whereby a release agent dispersion (i) with a release agent concentration of 23% was prepared.

### Example 1

### Preparation of Toner 1

### (5) The Salt Precipitation, Aggregation and Fusion Step of Forming the Toner Particles

Into a reaction container attached with a stirring device, a temperature sensor, a cooling pipe and a nitrogen introduction device, the following substance was poured, and a liquid temperature was adjusted at 30° C.

An aqueous solution in which 120 parts by mass of ion exchange water was added with:

| | |
|---|---|
| binder resin fine particle dispersion (i) | 1100 parts by mass; |
| carboxy-denatured polyurethane resin fine | 180 parts by mass; |
| particle dispersion (i) | |
| ion exchange water | 950 parts by mass; |
| colorant dispersion (i) | 100 parts by mass; and |
| sodium polyoxyethylenedodecylether sulfate | 3 parts by mass. |

Next, 5 mol/liter of an aqueous sodium hydroxide solution was added to an obtained mixed solution, and pH thereof was adjusted at 10. Then, an aqueous solution of 30° C., in which 35 parts by mass of magnesium chloride was dissolved into 35 parts by mass of ion exchange water, was added to such a reaction system in a stirred state for 10 minutes. Then, a temperature rise was started after the elapse of 3 minutes after the addition of the aqueous solution, the temperature of the reaction system was raised to 90° C. for 60 minutes, and aggregation thereof was promoted. A size of particles formed by the aggregation was observed by “Multisizer 3”.

When the median diameter (D₅₀) in the volume reference became 6.5 μm, 750 parts by mass of a 20% aqueous sodium chloride solution was added, and the aggregation was stopped.

After the addition of the 20% aqueous sodium chloride solution, the liquid temperature was heated to 98° C., and the stirring was continued. Then, fusion of the aggregated resin particles was promoted while observing average circularity of the particles concerned by a flow-type particle image analyzer “FPIA-2100”. When the average circularity became 0.965, the liquid temperature was cooled down to 30° C., and the stirring was stopped.

### (6) The Cooling/Washing Step, and (7) the Drying Step

After the addition of the 20% aqueous sodium chloride solution, the liquid temperature was heated to 98° C., and the stirring was continued. Then, the fusion of the aggregated resin particles was promoted while observing the average circularity of the particles by the flow-type particle image analyzer “FPIA-2100”. When the average circularity became 0.965, the liquid temperature was cooled down to 30° C., and the stirring was stopped.

The particles generated in the aggregation/fusion step were subjected to solid-liquid separation by a basket-type centrifugal separation machine “MARK III Model Number 60×40 (made by Matsumoto Machine Co., Ltd.) “, and a wet cake of the particles was formed. The wet cake was washed by ion exchange water of 45° C. by the above-described basket-type centrifugal separation machine until electric conductivity of the filterate became 5 μs/cm, was thereafter transferred to “Flash Jet Dryer (made by Seishin Enterprise Co., Ltd.) “, and was dried until a moisture content became 0.5% by mass. In such a way, particles were prepared.

### (8) The External Additive Addition Step

To the particles obtained as described above, there were added: 1% by mass of hydrophobic silica (number average primary particle diameter=12 nm); and 0.3% by mass of hydrophobic titania (number average primary particle diameter=20 nm). Then, a resultant was mixed by a Henschel mixer, and “Toner 1” was prepared.

A median diameter (D₅₀) of the obtained Toner 1 in the volume reference was 6.5 μm, and average circularity thereof was 0.965. Note that the median diameter (D₅₀) in the volume reference and the average circularity were values obtained by the measurements performed by the above-described methods.

### Example 2

### Preparation of Toner 2

In the preparation process of “Toner 1”, 180 parts by mass of the “carboxy-denatured polyurethane resin fine particle dispersion (i)” were used. Meanwhile, in Example 2, 180 parts by mass of the “carboxy-denatured polyurethane resin fine particle dispersion (ii)” were used. Other than this, similar operations were performed, and “Toner 2” was prepared.

### Example 3

### Preparation of Toner 3

Into a reaction device provided with a pH meter, an impeller and a thermometer, there were poured: 1100 parts by mass of the “carboxy-denatured polyurethane resin fine particle dispersion (ii)”; 180 parts by mass of the “binder resin fine particle dispersion (ii)”; 32 parts by mass of a “20% aqueous sodium dodecylbenzene sulfonate solution”; and 1300 parts by mass of ion exchange water, followed by stirring at 200 rpm for 15 minutes. This mixture was further stirred, and the respective components were given sufficient affinity with one another, and thereafter, 100 parts by mass of the colorant dispersion (i) and 201 parts by mass of the release agent dispersion (i) were added thereto, followed by mixing. Thereafter, 0.3 M of an aqueous nitric acid solution was added to this raw material mixture, and pH thereof was adjusted at 2.7.

Subsequently, while applying shearing force to the mixture at 1000 rpm by Ultraturrax (made by IKA Labortechnik GmbH), 250 parts by mass of a 10% aqueous aluminum sulfate solution was dropped as an aggregation agent thereto. After such dropping of the aggregation agent was ended, the number of revolutions of Ultraturrax was increased to 6000 rpm to perform stirring for 5 minutes, and the aggregation agent and the raw material mixture were sufficiently mixed with each other. Thereafter, the temperature rise, the aggregation, the fusion and the washing/drying were performed in a similar way to the preparation process of Toner 1, and “Toner 3” with a volume average particle diameter of 6.5 μm was prepared.

### Example 4

### Preparation of Toner 4

In the preparation process of “Toner 1”, 180 parts by mass of the “carboxy-denatured polyurethane resin fine particle dispersion (i)” were used. Meanwhile, in Example 4, 110 parts by mass of the “carboxy-denatured polyurethane resin fine particle dispersion (iii)” were used. Other than this, similar operations were performed, and “Toner 4” was prepared.

### Example 5

### Preparation of Toner 5

In the preparation process of “Toner 4”, 110 parts by mass of the “carboxy-denatured polyurethane resin fine particle dispersion (iii)” were used. Meanwhile, in Example 5, 110 parts by mass of the “carboxy-denatured polyurethane resin fine particle dispersion (iv)” were used. Other than this, similar operations were performed, and “Toner 5” was prepared.

### Example 6

### Preparation of Toner 6

In the preparation process of “Toner 3”, 180 parts by mass of the “carboxy-denatured polyurethane resin fine particle dispersion (ii)” were used. Meanwhile, in Example 6, 110 parts by mass of the “carboxy-denatured polyurethane resin fine particle dispersion (v)” were used. Other than this, similar operations were performed, and “Toner 6” was prepared.

### Example 7

### Preparation of Toner 7

In the preparation process of “Toner 1”, 1100 parts by mass of the “binder resin fine particle dispersion (i)” were used, and 180 parts by mass of the “carboxy-denatured polyurethane resin fine particle dispersion (i)” were used. Meanwhile, in Example 7, 1100 parts by mass of the “binder resin fine particle dispersion (iii)” were used, and 180 parts by mass of the “carboxy-denatured polyurethane resin fine particle dispersion (vi)” were used. Other than these, similar operations were performed, and “Toner 7” was prepared.

### Example 8

### Preparation of Toner 8

In the preparation process of “Toner 7”, 1100 parts by mass of the “binder resin fine particle dispersion (iii)” were used, and 180 parts by mass of the “carboxy-denatured polyurethane resin fine particle dispersion (vi)” were used. Meanwhile, in Example 8, 1100 parts by mass of the “binder resin fine particle dispersion (ii)” were used, and 277 parts by mass of the “carboxy-denatured polyurethane resin fine particle dispersion (vi)” were used. Other than these, similar operations were performed, and “Toner 8” was prepared.

### Example 9

### Preparation of Toner 9

In the preparation process of “Toner 7”, 180 parts by mass of the “carboxy-denatured polyurethane resin fine particle dispersion (vi)” were used. Meanwhile, in Example 9, 180 parts by mass of the “carboxy-denatured polyurethane resin fine particle dispersion (vii)” were used. Other than this, similar operations were performed, and “Toner 9” was prepared.

### Example 10

### Preparation of Toner 10

In the preparation process of “Toner 9”, 180 parts by mass of the “carboxy-denatured polyurethane resin fine particle dispersion (vii)” were used. Meanwhile, in Example 10, 180 parts by mass of the “carboxy-denatured polyurethane resin fine particle dispersion (viii)” were used. Other than this, similar operations were performed, and “Toner 10” was prepared.

### Comparative Example 1

### Preparation of Toner 11

<Preparation of Polyurethane Resin Fine Particle (i)>

Into a flask, there were poured: 830 parts by mass of 265 Excenol 1030 (polyether polyol/Asahi Class Co., Ltd.); 1000 parts by mass of Takenate 600 (diisocyanate/Mitsui Chemicals, Inc.); and 10 parts by mass of trimethylol propane. Then, nitrogen is substituted for air in the flask, and a temperature of these components was raised while stirring the components. While stirring the components, a reaction thereof was continued at a temperature of 130° C. for 15 hours. Next, when the temperature became 30° C., 400 parts by mass of toluene were added, and further, 200 parts by mass of a 15% aqueous polyvinyl alcohol solution were added, followed by stirring. While stirring such a resultant, the temperature thereof was raised again. When the temperature became 75° C., the resultant was left standing for 1 hour while being stirred. Subsequently, the heating was discontinued, and when the temperature became 30° C. or less, the resultant was subjected to the solid-liquid separation by the filtration. Resin particles thus obtained were put into ion exchange water of 45° C., followed by stirring for 30 minutes, and thereafter, such a mixture was subjected to the solid-liquid separation again. This washing was repeated five times, followed by drying. In the drying, the mixture was frozen at −30° C. in a vacuum state, thereafter, the temperature was gradually raised to reach 45° C., and the mixture was left standing for 18 hours. In such a way, the drying was ended. In such a manner as described above, “polyurethane resin fine particles (i)” with a volume average particle diameter of 3.5 μm were obtained. The number of residual isocyanate radicals was 1.6%.

<Preparation of Polyurethane Resin Fine Particle Dispersion (i)>

| | |
|---|---|
| Polyurethane resin fine particle (i) | 400 parts by mass |
| Neogen SC (Dai-Ichi Kogyo Seiyaku Co., Ltd.) | 30 parts by mass |
| Ion exchange water | 1200 parts by mass |
| Methyl alcohol | 400 parts by mass |

The above-described components were sufficiently stirred and dispersed by the homogenizer (Ultraturrax T50, made by IKA Labortechnik GmbH), whereby a polyurethane resin fine particle dispersion for comparison, in which a concentration of a solid content was 20%, was obtained. An obtained dispersion diameter was 4.0 μm.

<Preparation of Release Agent (ii)>

| | |
|---|---|
| Paraffin wax (HNP-9, made by Nippon Seiro Co., | 400 parts by mass |
| Ltd.) | |
| Sodium dodecylbenzene sulfonate (Neogen SC, made | 20 parts by mass |
| by Dai-Ichi Kogyo Seiyaku Co., Ltd.) | |
| Ion exchange water | 600 parts by mass |

The above-described components were heated to 120° C., and were dispersed under a pressure of 50 MPa by a pressure discharge-type homogenizer, whereby a release agent dispersion (ii) was adjusted. A solid content of this wax dispersion 1 was 20%. Moreover, fusion viscosity of HNP-9 at 140° C. was 4.8 mPa·s.

<Preparation of Binder Resin Fine Particle Dispersion (iv)>

| | |
|---|---|
| ethylene glycol (made by Wako Pure Chemical | 50 parts by mass |
| Industries, Ltd.) | |
| neopentyl glycol (made by Wako Pure Chemical | 65 parts by mass |
| Industries, Ltd.) | |
| terephthalic acid (made by Wako Pure Chemical | 96 parts by mass |
| Industries, Ltd.) | |

The above-described monomers were put into a flask, a temperature thereof was raised to 190° C. for 1 hour, and it was confirmed that such a reaction system was uniformly stirred. Thereafter, 1.2 parts by mass of dibutyl tin oxide was poured. Moreover, the temperature was raised to 240° C. while evaporating generated water, and further, a dehydration/condensation reaction was continued for 4 hours at 240° C., whereby binder resin particles (iv) were obtained.

Subsequently, while being left in a molten state, the obtained particles were transferred to Cavitron CD1010 (made by Eurotech Co., Ltd) at a rate of 100 g per minute. Into an aqueous medium tank prepared separately, dilute ammonia water with a concentration of 0.37% by mass, in which reagent ammonia water was diluted by ion exchange water, was poured. Then, while being heated to 120° C. by a heat exchanger, the diluted ammonia water was transferred to the above-described Cavitron at a rate of 0.1 liter per minute at the same time when the above-described polyester resin molten body was transferred thereto. Cavitron was operated under conditions where a rotation speed of a rotator was 60 Hz, and a pressure was 5 kg/cm². Then, a binder resin fine particle dispersion (iv) with a solid content of 30% was obtained. A volume reference median diameter of the binder resin fine particle dispersion (iv) was 430 nm.

<Preparation of Colorant Dispersion (ii)>

| | |
|---|---|
| Cyan pigment | 10 parts by mass |
| | (Pigment Blue 15:3, made by Dainichiseika Color & |
| | Chemicals Mfg. Co., Ltd.) |
| Anionic surfactant | 2 parts by mass |
| | (Neogen SC, made by Dai-Ichi Kogyo Seiyaku Co., |
| | Ltd.) |
| Ion exchange water | 80 parts by mass |

The above-described components were mixed with one another, and were dispersed for 1 hour by the high pressure impact-type dispersing machine Ultimizer (HJP30006, made by Sugino Machine Limited), whereby a colorant dispersion (ii) with a solid content of 20% was obtained.

### <Preparation of Toner 11>

| | | |
|---|---|---|
| Binder resin fine particle dispersion (iv) | 1100 | parts by mass |
| Polyurethane resin fine particle dispersion (i) | 180 | parts by mass |
| Colorant dispersion (ii) | 100 | parts by mass |
| Release agent dispersion (ii) | 200 | parts by mass |
| Polyaluminum chloride | 0.8 | parts by mass |
| Ion exchange water | 1000 | parts by mass |

In a stainless steel-made round flask, the above-described components were sufficiently mixed/dispersed by using Ultraturrax T50 made by IKA Labortechnik GmbH. Then, the components were heated up to 48° C. while shaking the flask in a heating oil bath. After holding the components at 48° C. for 60 minutes, 80 parts by mass of the same resin dispersion 1 as above was gently added thereto. Thereafter, pH in the system was adjusted at 8.0 by using an aqueous sodium hydroxide solution with a concentration of 0.5 mol/L. Thereafter, the stainless steel-made flask was hermetically sealed, and a seal of a stirring shaft was magnetically sealed, and then the flask was heated up to 90° C. while being continued to be shaken, and was held for 3 hours. After the end of the reaction, a reaction resultant was cooled down at a temperature drop rate of 2° C./minute, was then subjected to filtration and sufficient washing by the ion exchange water, and was subjected to the solid-liquid separation by the Nutsche-type suction filtration. This was dispersed one more time by using 3 L of ion exchange water of 30° C., and was stirred/washed at 300 rpm for 15 minutes. This washing operation was further repeated six times. When pH of such filtrate became 7.54, and electric conductivity thereof became 6.5 μs/cm, the solid-liquid separation was performed by the Nutsche-type suction filtration by using No 5A filter paper. Subsequently, vacuum drying was continued for 12 hours, whereby toner was obtained.

Moreover, to this toner, there were added: silica (SiO₂) fine particles with a primary particle average particle diameter of 40 nm, which was subjected to surface hydrophobic treatment by hexamethyl disilazane; and metatitanic acid compound fine particles with a primary particle average particle diameter of 20 nm, which was a reaction product of metatitanic acid and isobutyltrimethoxysilane, so that coverage factors of the respective coloring particles to the surfaces could become 40%, followed by mixing by the Henschel mixer, whereby Toner 11 was obtained.

### Comparative Example 2

### Preparation of Toner 12

<Preparation of Polyurethane Resin Fine Particle (ii)>

In <Preparation of carboxy-denatured polyurethane resin fine particle (iii)>, “15 parts by mass of maleic acid” was used in order to denature the unreacted isocyanate radicals to the carboxylic acid. Meanwhile, in Comparative 2, the above-described usage was changed to “0 part by mass of maleic acid”. Other than this, similar operations were performed, and polyurethane resin fine particles (ii) were obtained. The number of residual isocyanate radicals was 1.4%.

<Preparation of Polyurethane Resin Fine Particle Dispersion (ii)>

In the preparation of the carboxy-denatured polyurethane resin fine particle dispersion (vi), the carboxy-denatured polyurethane resin fine particles (iii) were used. Meanwhile, here, the particles were changed to the polyurethane resin fine particles (ii). In a similar way other than this, a polyurethane resin fine particle dispersion (ii) was prepared.

An obtained dispersion diameter was 300 nm.

### <Preparation of Toner 12>

In the preparation process of “Toner 2”, 180 parts by mass of the “carboxy-denatured polyurethane resin fine particle dispersion (ii)” were used. Meanwhile, here, 180 parts by mass of the “polyurethane resin fine particle dispersion (ii)” were used. Other than this, similar operations were performed, and “Toner 12” was prepared.

### Comparative Example 3

### Preparation of Toner 13

In the preparation process of “Toner 12”, 180 parts by mass of the “polyurethane resin fine particle dispersion (ii)” were used. Meanwhile, in Comparative example 3, 0 part by mass of the “polyurethane resin fine particle dispersion (ii)” was used. Other than this, similar operations were performed, and “Toner 13” was prepared.

### EVALUATION

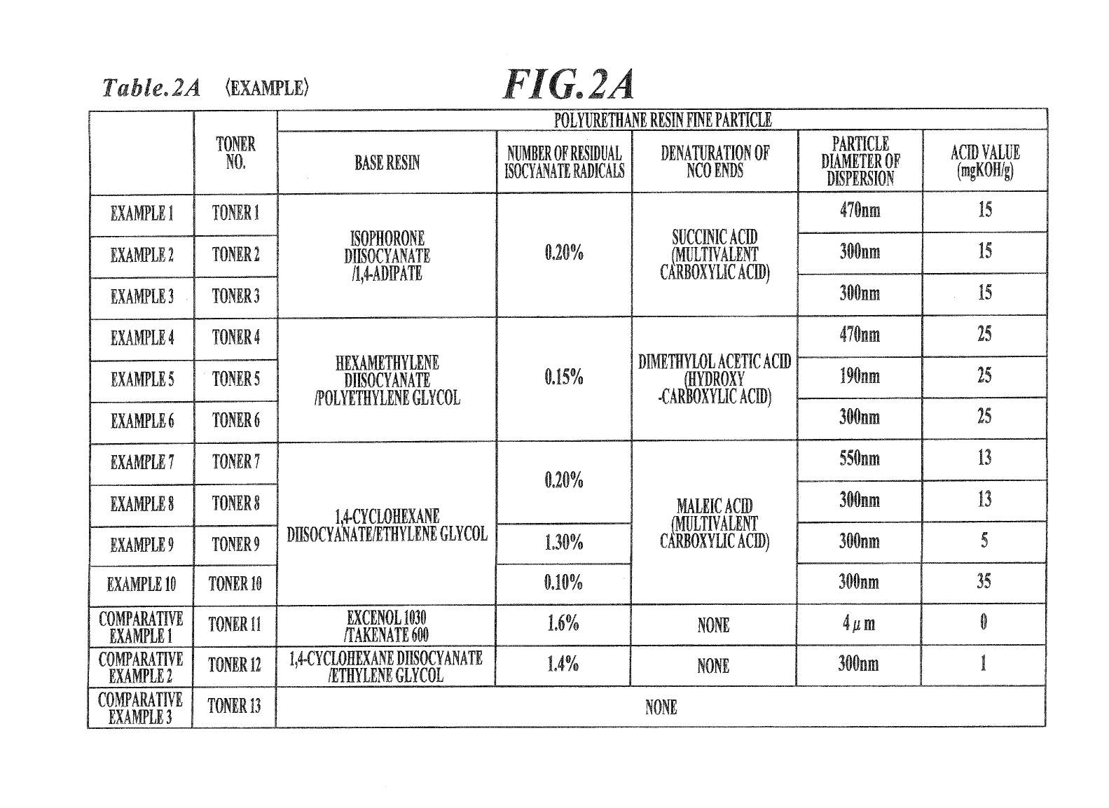

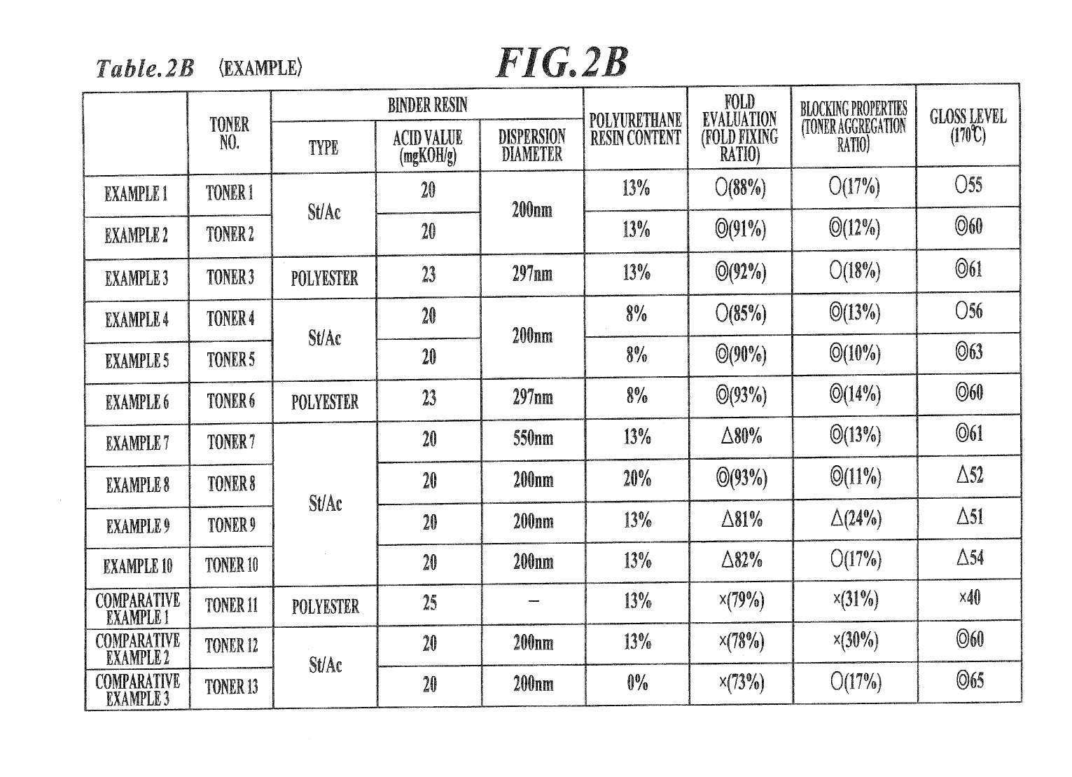

As an evaluation device, a commercially available multifunction printer “bizhub Pro 0500 (made by Konica Minolta Business Technologies, Inc.) was used. Then, the toners prepared as described above were sequentially loaded into the above-described evaluation device, and were evaluated on the following items under a normal-temperature and normal-humidity environment (20°, 55% RH). Evaluation results are shown in Tables 2A and 2B described in FIGS. 2A and 2B.

### <Fold Fixing Strength>

With regard to fold fixing strength, a fixing ratio of each toner image in a fold on a sheet when a surface temperature of a heating roller was set at 170° C. was evaluated. Specifically, a degree of toner peeling in a folded portion when the fixed image of the toner was folded inward was evaluated as the fixing ratio.

With regard to a measurement method, an image surface of a solid image portion (image density was 0.8) was folded inward, and was rubbed by the finger three times, and thereafter, the image was opened and wiped off three times by “JK Wiper (made by Nippon Paper Crecia Co., LTD.). Then, the fixing ratio is a value calculated by the following expression from image densities of the folded portion of the solid image before and after being folded.

Fixing ratio (%)=(image density after fold)/(image density before fold)×100

From the respective fixing ratios thus obtained, the fold fixing strength was evaluated as below, and those of “∘” or better were regarded as acceptable.

### Evaluation Criteria

⊚: The fixing ratio of the fold at each temperature became 90 to 100% (excellent)
∘: The fixing ratio of the fold at each temperature became 85 to less than 90% (good)
Δ: The fixing ratio of the fold at each temperature became 80% to less than 85% (applicable)
x: There were some in which the fixing ratio of the fold became less than 80% (inapplicable)

### <Blocking Resistance>

0.5 g of the toner was taken into a glass bottle with a capacity of 10 ml and an inner diameter of 21 mm, and a cap was closed. Then, the glass bottle was shaken 600 times at room temperature by Tap Denser KYT-2000 (made by Seishin Enterprise Co., Ltd.). Thereafter, in a state where the cap was taken off, the glass bottle was left standing under an environment of 55° C. and 35% RH for two hours. Subsequently, the toner was mounted on a sieve with 48 meshes (aperture: 350 μm) while paying attention so as not to crash the aggregate of the toner, was set on Powder Tester (made by Hosokawa Micron Group), was fixed by a pressing bar and a knob nut, was adjusted at a vibration strength with a feed width of 1 mm, and was applied with vibrations for 10 seconds. Thereafter, a ratio (% by mass) of a quantity of the toner remaining on the sieve was measured.

An aggregation ratio of the toner is a value calculated by the following expression.

(Toner aggregation ratio (%))=(mass (g) of residual toner on sieve)/0.5 (g)×100

A heat-resistant storage capability of the toner was evaluated according to the criteria described below, and those of “∘” or better were regarded as acceptable.

### Evaluation Criteria

⊚: The toner aggregation ratio was less than 15% by mass (the heat-resistant storage capability is extremely good)
∘: The toner aggregation ratio was 20% by mass or less (the heat-resistant storage capability is good)
Δ: The toner aggregation ratio is 20% by mass or more and 25% by mass or less (acceptable though a little inferior to “∘: good”)
x: The toner aggregation ratio exceeds 25% by mass (unacceptable since the heat-resistant storage capability of the toner is poor)

### <Gloss Evaluation>

An unfixed toner image with a toner quantity of 0.5 mg/cm² was used, and supply of the release agent oil to the heating roller was stopped, and the release agent oil was not allowed to be substantially present on the surface of the heating roller. In this state, a test was conducted at 160° C. At this time, a gloss level of each fixing sample at 75 degrees was measured by using Gloss Meter (made by Murakami Color Research Laboratory), and was evaluated as below. Those of 50 or better of the gloss level were regarded as acceptable.

⊚: 60 or more
∘: 55 or more to less than 60
Δ: 50 or more to less than 55
x: 10 or more to less than 50

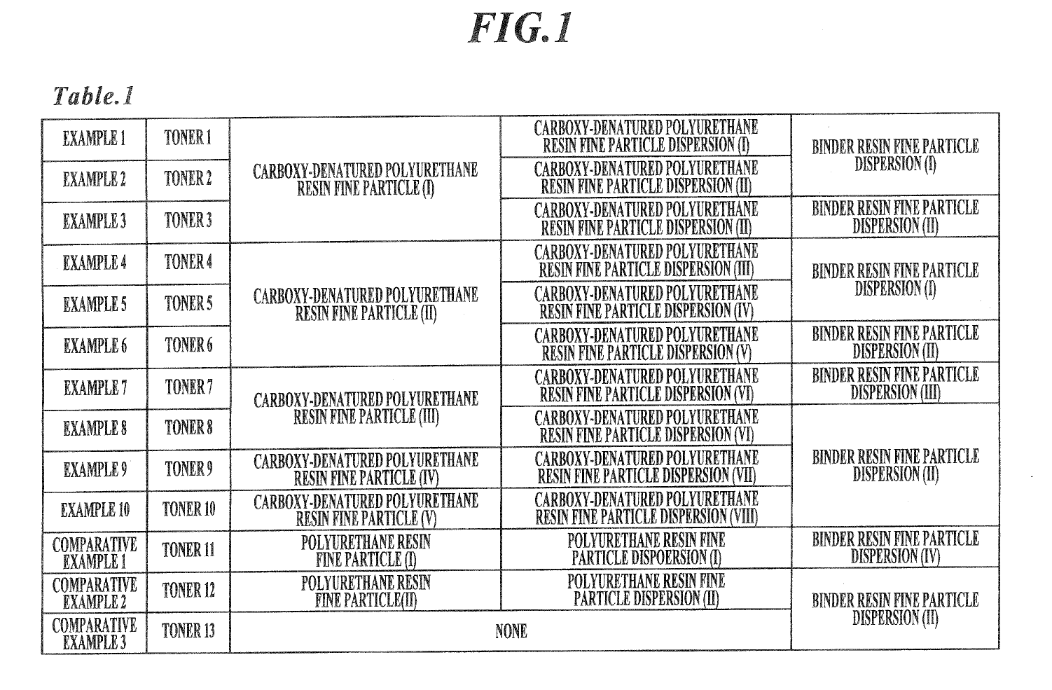

Note that Table 1 described in FIG. 1 shows types of the carboxy-denatured polyurethane resin fine particles, the carboxy-denatured polyurethane resin fine particle dispersions, and the binder resin fine particle dispersions, which compose Toner 1 to Toner 10, and types of the polyurethane resin fine particles, the polyurethane resin fine particle dispersions and the binder resin fine particle dispersions, which compose Toner 11 to Toner 13.

Moreover, besides the above-described evaluation results, Tables 2A and 2B show the base resins of the polyurethane resin fine particles which compose Toners 1 to 13, the number of residual isocyanate radicals of the polyurethane resin fine particles concerned, the carboxylic acids reacted in order to denature the unreacted isocyanate radicals of the polyurethane resin fine particles, and the particle diameters and acid values of the polyurethane resin fine particle dispersions. Furthermore, Tables 2A and 2B show the types and acid values of the binder resins, the dispersion diameters of the binder resin fine particle dispersions, and the contents of the polyurethane resins in the toners.

From the results in Tables 2A and 2B, it is recognized that Toners 1 to 10 containing the carboxy-denatured polyurethane resins are superior in the fold fixing ration, the blocking resistance and the gloss level to Toners 11 to 13 containing the polyurethane resins without the carboxy denaturation.

Thus, in accordance with the present invention, the toner excellent in blocking resistance can be obtained in such a manner that the fold fixing performance is enhanced without bringing about the gloss decrease.

What is claimed is:

1. A toner comprising at least a binder resin, a colorant and a polyurethane resin,
wherein the polyurethane resin is a carboxy-denatured polyurethane resin.

2. The toner as claimed in claim 1, wherein the polyurethane resin is the carboxy-denatured polyurethane resin having an isocyanate radical in a molecular chain, the carboxy-denatured polyurethane resin being reacted with at least one or more compounds selected from following (a):
(a) a multivalent carboxylic acid, a hydroxyl-carboxylic acid compound.

3. The toner as claimed in claim 1, wherein the polyurethane resin is the carboxy-denatured polyurethane resin having an isocyanate radical in a molecular chain, the carboxy-denatured polyurethane resin being reacted with a hydroxyl-carboxylic acid compound.

4. The toner as claimed in claim 1, wherein the polyurethane resin is the carboxy-denatured polyurethane resin having an isocyanate radical in a molecular chain, the carboxy-denatured polyurethane resin being reacted with a dimethylol acetate.

5. The toner as claimed in claim 1, wherein the polyurethane resin is the carboxy-denatured polyurethane resin having an isocyanate radical in a molecular chain, the carboxy-denatured polyurethane resin being reacted with a multivalent carboxylic acid.

6. The toner as claimed in claim 1, wherein the polyurethane resin is the carboxy-denatured polyurethane resin having an isocyanate radical in a molecular chain, the carboxy-denatured polyurethane resin being reacted with a succinic acid.

7. The toner as claimed in claim 1, wherein a content ratio of the carboxy-denatured polyurethane resin in the toner is 3 to 15 parts by mass.

8. The toner as claimed in claim 1, wherein the number of isocyanate radicals remaining in the carboxy-denatured polyurethane resin is 0.5% or less with respect to the number of entire isocyanate radicals in an isocyanate compound required to synthesize the polyurethane resin.

9. The toner as claimed in claim 1, wherein an acid value of the carboxy-denatured polyurethane resin is 5 to 25 mgKOH/g.

10. The toner as claimed in claim 1, wherein an acid value of the binder resin is 5 to 30 mgKOH/g.

11. A method of producing a toner containing at least a binder resin, a colorant and a polyurethane resin, the method comprising the steps of:
1) reacting at least one compound selected from following (a) with the polyurethane resin having an isocyanate radical in a molecular chain, and preparing a carboxy-denatured polyurethane resin, wherein
(a) a multivalent carboxylic acid, a hydroxyl-carboxylic acid compound;
2) dispersing the carboxy-denatured polyurethane resin within a range where a volume reference median diameter is 100 to 500 nm, and preparing a carboxy-denatured polyurethane resin fine particle dispersion; and
3) mixing a binder resin fine particle dispersion with a volume reference median diameter of 60 to 500 nm, the carboxy-denatured polyurethane resin fine particle dispersion and a colorant dispersion with one another, aggregating binder resin fine particles, carboxy-denatured polyurethane resin fine particles and colorant particles in an aqueous medium, and forming toner particles.
